(19) United States
(12) Patent Application Publication
(10) Pub. No.: US 2009/0104396 A1
(43) Pub. Date: Apr. 23, 2009

(54) COLOR PATTERN FILM FOR METAL SHELL

(75) Inventors: Chien-Chun Wu, Taipei City (TW); Chen-Hua Liu, Taipei City (TW); Bar-Long Denq, Taipei City (TW); Yu-Ju Chen, Taipei City (TW); Ru-Jen Chiu, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: COMPAL ELECTRONICS, INC., Taipei City (TW)

(21) Appl. No.: 12/025,059

(22) Filed: Feb. 4, 2008

(30) Foreign Application Priority Data
Oct. 17, 2007 (CN) 200710182316.7

(51) Int. Cl. B32B 33/00

(52) U.S. Cl. 428/99

(57) ABSTRACT

A color pattern film for metal shell is provided. The color pattern film for metal shell includes a transparent polymer substrate, a releasing coating layer, a protective layer, an ink layer, and an adhesive layer. The releasing coating layer is on the transparent polymer substrate, the protective layer is on the releasing coating layer, the ink layer is on the protective layer, and the adhesive layer is on the ink layer. The adhesive layer at least includes a base resin which is one of resin systems selected from ethylene-vinyl acetate (EVA), polyester (PET) resin, and polyolefin resin. The color pattern film for metal shell can be directly pressed and attached onto a metal sheet or coil, and subsequently punched, thus the problems of the prior art that the yield of adhesive wet film coating process is not easily controlled and complex post-processes are still required after molding are addressed.

### CROSS-REFERENCE TO RELATED APPLICATION

This application claims the priority benefit of Chinese application serial no. 200710182316.7, filed on Oct. 17, 2007. The entirety of the above-mentioned patent application is hereby incorporated by reference herein and made a part of this specification.

### BACKGROUND OF THE INVENTION

1. Field of the Invention

The present invention generally relates to a technique of shaping the appearance of a metal shell, in particular, to a color pattern film for metal shell.

2. Description of Related Art

Three types of the methods of shaping the appearance of a metal shell exist.

The first method is a spraying painting technology to molded metal shell, which includes the following steps, as shown in FIG. 1. Firstly, a lacquer is prepared (Step 100),and a metal shell is molded (Step 102). Next, the lacquer is sprayed on the molded metal shell (Step 104), and then, baked and dried to cure the lacquer (Step 106). However, for manufacturers and suppliers, after the metal material is obtained, stepwise operation of Steps 102 to 106 is still required, thus the processes and the cost are additionally increased. Further, as the appearance spraying is mostly semi-automatically or manually operated, it is not easy to control the painting quality.

The second method is a heat transfer technology to molded metal shell, as shown in FIGS. 2A and 2B.

Firstly, referring to FIG. 2A, a heat transfer film 200 capable of transferring images and color grains includes a polymer substrate 202, a releasing coating layer 204, an ink layer 206, and an adhesive 208. For manufacturing of the heat transfer film sheet 200, firstly the releasing coating layer 204 is coated on one surface of the polymer substrate 202, then the ink layer 206 is printed on the exposed surface of the releasing coating layer 204, and finally the adhesive 208 is coated on the exposed surface of the ink layer 206. Thereafter, the heat transfer film sheet 200 is covered on a surface of the molded metal shell 210 and subjected to an appropriate temperature and pressure, so as to make the adhesive layer 208 adhered to the molded metal shell 210.

Finally, referring to FIG. 2B, the polymer substrate 202 is peeled off, so as to transfer the images and the color grains of the heat transfer film sheet 200 to the surface of the molded metal shell 210. In addition, as the polymer substrate 202 is moved, the ink layer 206 is exposed to the air and is not protected, so it is necessary to coat a protective film layer 212 on the ink layer 206, thus the processes and the cost are additionally increased, and it is not easy to control the quality. Furthermore, the heat transfer technology is not suitable for the application in the molded metal shells with complex surface.

The third method is film lamination technology for metal sheet material or coil material, as shown in FIG. 3. According to the method, firstly a polymer film 300 is fabricated, then an adhesive 304 is coated on a surface of a metal sheet material or coil material 302, and then the polymer film 300 is attached thereon. Then, it is necessary to perform a heating braking process and an adhesive curing process, so as to make the polymer film closely attached to the metal sheet material or coil material. Finally, it is necessary to perform a molding process on the metal plate material or coil material with the polymer film attached thereon according to requirements.

Main function of the polymer film is to protect the metal surface or provide artificial sense of other materials (for example, wood grain), so it is necessary to perform a baking process and an adhesive curing process to ensure the close attachment of the polymer film and the metal. Therefore, it is further necessary to tightly control the processes and the stability of the adhesive, thus the manufacturing cost is increased. In addition, the adhesive 304 used in the third method contains a great number of solvents and does not satisfy current requirements on environmental protection.

All the above conventional arts respectively have the disadvantages that the process yield is poor, and the appearance design, pattern positioning accuracy, and processes are too complex.

### SUMMARY OF THE INVENTION

Accordingly, the present invention is directed to a color pattern film for metal shell, which can be manufactured without the adhesive wet film coating process in the conventional art, so the yield is easily controlled, the current requirements on environmental protection are met, and the protection of high hardness, abrasion resistance, and chemicals resistance are provided.

In order to realize the above objective, the color pattern film for metal-shell of the present invention includes:
a transparent polymer substrate;
a releasing coating layer, located on the transparent polymer substrate;
a protective layer, located on the releasing coating layer;
an ink layer, located on the protective layer; and
an adhesive layer, located on the ink layer, at least including a base resin, which is one of resin systems selected from ethylene-vinyl acetate (EVA), polyester (PET) resin, and polyolefin resin.

In the color pattern film for metal shell, the adhesive layer further includes a tackifier, a plasticizer, an antioxidant, and a wax.

In the color pattern film for metal shell, the solid content of the adhesive layer is between 90 and 100 wt %.

In the color pattern film for metal shell, the adhesive layer further includes a thermosetting resin.

In the color pattern film for metal shell, the thermosetting resin is one selected from a resin system consisting of acrylic resin and urethane resin or composites thereof.

In the color pattern film for metal shell, the melting temperature of the adhesive layer is lower than 200° C.

In the color pattern film for metal shell, the glass transition temperature of the adhesive layer is higher than 60° C.

In the color pattern film for metal shell, the content of the base resin in the adhesive layer is between 20 and 80%.

In the color pattern film for metal shell, the adhesive layer is free of solvents.

In the color pattern film for metal shell, the thickness of the adhesive layer is 10-100 μm.

In the color pattern film for metal shell, the transparent polymer substrate is made of a material without polyvinyl chloride resin.

In the color pattern film for metal shell, the thickness of the transparent polymer substrate is 20-200 μm.

In the color pattern film for metal shell, the material of the transparent polymer substrate includes acrylic resin, PET resin, polystyrene (PS) resin, polypropylene (PP) resin, polyethylene (PE) resin, polycarbonate (PC) resin, or polyurethane (PU) resin.

In the color pattern film for metal shell, the material of the protective layer is one resin selected from a resin system consisting of acrylic resin, PU resin, epoxy resin, and PET resin.

In the color pattern film for metal shell, the protective layer is composed of thermosetting resin and UV curing resin.

In the color pattern film for metal shell, the protective layer further includes a curing agent for the thermosetting resin and a photoinitiator for the UV curing system.

The color pattern film for metal shell of the present invention can be directly pressed and attached onto a metal sheet material or a coil material to form a color grain metal plate material or coil material, which can be subsequently punched and subjected to other processing, so the problems of the conventional art that the yield of adhesive wet film coating process is not easily controlled and complex post-processes are still required after molding are addressed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a step view of a well-known spray painting technology to molded metal shell.

FIGS. 2A and 2B are process cross-sectional views of a well-known heat transfer technology to molded metal shell.

FIG. 3 is a process cross-sectional view of a well-known conventional film lamination technology for metal sheet material or coil material.

FIG. 4 is a cross-sectional exploded view of a color pattern film for metal shell according to an embodiment of the present invention.

FIGS. 5A to 5C are process cross-sectional views of a color pattern film for metal shell of an embodiment applied to the appearance of a metal shell.

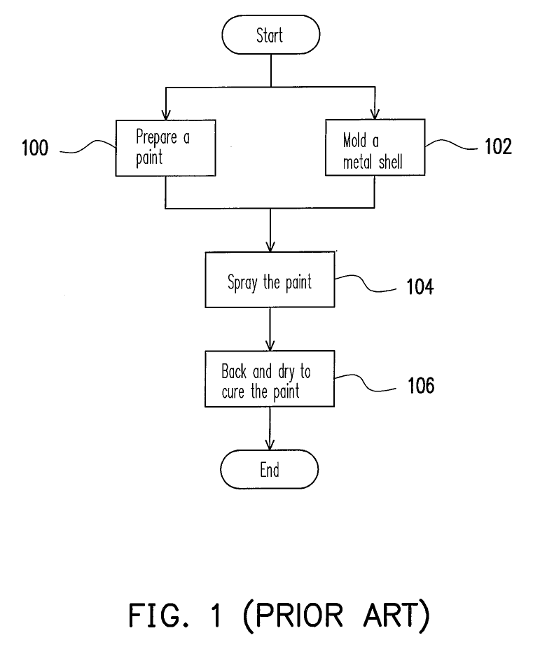

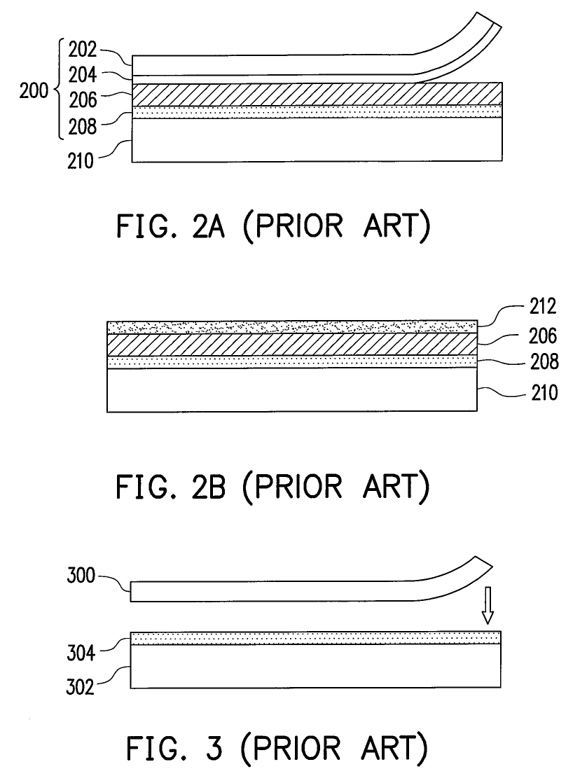

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

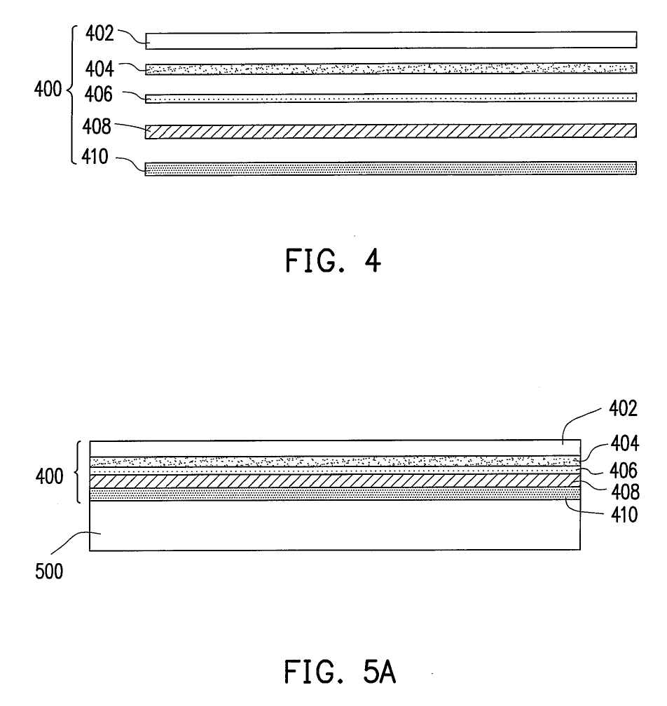

FIG. 4 is a cross-sectional exploded view of a color pattern film for metal shell according to an embodiment of the present invention.

Referring to FIG. 4, a color pattern film for metal shell 400 of this embodiment includes a transparent polymer substrate 402, a releasing coating layer 404, a protective layer 406, an ink layer 408, and an adhesive layer 410. The ink layer 408 is located under the protective layer 406, and the adhesive layer 410 is located under the ink layer 408. Definitely, if FIG. 4 is inversely viewed, the ink layer 408 is located on the protective layer 406, and the adhesive layer 410 is located on the ink layer 408. The adhesive layer 410 at least includes a base resin, which is one of resin systems selected from EVA, PET resin, and polyolefin resin. The solid content of the adhesive layer 410 is, for example, between 90 and 100 wt %, and preferably between 95 and 100 wt %, such that the thickness of the adhesive layer 410 and the color pattern film for metal shell 400 can be easily controlled.

Referring to FIG. 4 again, if necessary, the adhesive layer 410 can further include a tackifier, a plasticizer, an antioxidant, and a wax. In addition, in order to enhance the adhering strength, a certain proportion of a thermosetting resin can be added into the adhesive layer 410, for example, one resin selected from a resin system consisting of acrylic resin and urethane resin or composites thereof. Further, the melting temperature (Tₘ) of the adhesive layer 410 in a first embodiment is, for example, lower than 200° C., and the glass transition temperature (T_{g}) is, for example, higher than 60° C. The content of the base resin in the adhesive layer 410 is selectively between 20 and 80%. The adhesive layer 410 in this embodiment is free of solvents, and the thickness is, for example, 10-100 μm. The thickness of the transparent polymer substrate 402 is, for example, 20-200 μm. Further, for the purposes of environmental protection, the transparent polymer substrate 402 is selectively made of a material without polyvinyl chloride resin, and the material is, for example, acrylic resin, PET resin, PS resin, PP resin, PE resin, PC resin, or PU resin, and it is PET resin in this embodiment. The material of the protective layer 406 is, for example, one resin selected from a resin system consisting of acrylic resin, PU resin, epoxy resin, and PET resin. Further, the protective layer 406 is composed of a thermosetting resin and a UV curing resin, and further includes a curing agent for the thermosetting resin and a photoinitiator for the UV curing system.

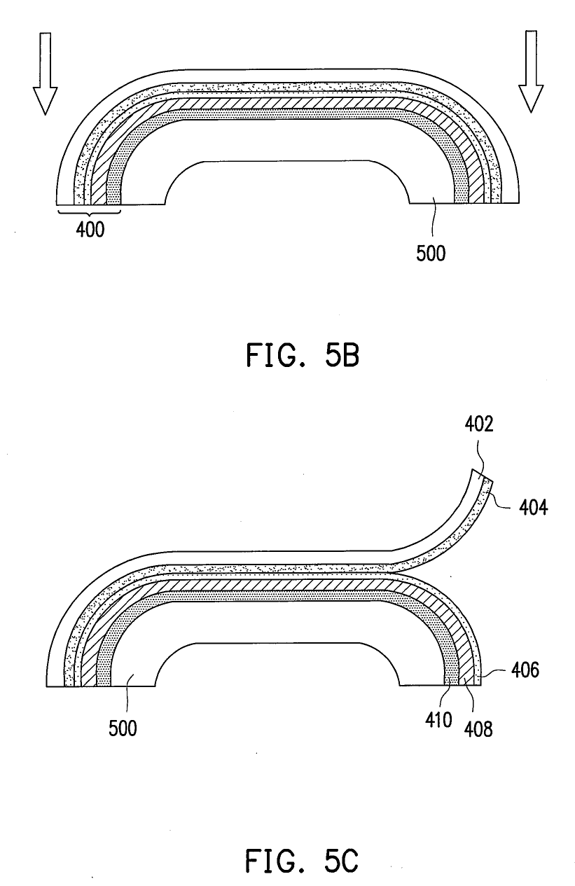

FIGS. 5A to 5C are process cross-sectional views of the color pattern film for metal shell of the embodiment applied to the appearance of a metal shell.

Referring to FIG. 5A, a releasing coating layer 404 is firstly coated on one surface of a transparent polymer substrate 402, then a curable protective layer 406 is coated on the releasing coating layer 404, next an ink layer 408 is printed, and finally an adhesive layer 410 is attached to the ink layer 408, so as to form a color pattern film for metal shell 400 having images and color grains, which can be a film sheet or a film coil. Next, the color pattern film for metal shell 400 is covered on a surface of a metal sheet material or a coil material 500, and a lamination process of applying appropriate temperature, pressure, and time on the back surface of the color pattern film for metal shell 400 is performed, such that the adhesive layer 410 gets adhesive when being heated and is closely attached to the metal sheet material or coil material 500, thereby forming the structure of FIG. 5A.

The protective layer 406 in this embodiment can be composed of a thermosetting resin and a UV curing resin, in which a curing agent for the thermosetting resin and a photoinitiator for the UV curing system are added. Therefore, firstly, the thermosetting resin and the curing agent in the protective layer 406 firstly react with each other by performing a lamination process with the metal sheet material or coil material 500 to form a half-cured state and be transparent. The half-cured protective layer 406 is beneficial to the subsequent process of shaping the appearance, for example, punching, such that the molded protective layer 406 is prevented from being cracked or damaged because of an excessively high hardness and action forces during processing.

Next, referring to FIG. 5B, the metal sheet material or coil material 500 having the color pattern film for metal shell 400 attached thereon is cut and subjected to appropriate processing (for example, punching) procedures, and at the same time, is made into a metal shell having a three-dimensional structure and the color pattern film for metal shell 400 attached thereon by means of the extension and flexibility of the color pattern film for metal shell 400 and the metal sheet material or coil material 500.

Next, referring to FIG. 5C, the transparent polymer substrate 402 is torn off so that the images and the color grains on the color pattern film for metal shell 400 are transferred to the metal shell. Next, a curing treatment is optionally performed to the finished color grain metal shell (including the protectively layer 406, the ink layer 408, the adhesive layer 410, and the punched metal sheet material or coil material 500) after the transfer. The curing treatment includes radiation; for example, the UV curing resin in the protective layer 406 is bonded by irradiating with UV, such that the ink layer 408 is protected by the protective layer 406 having high hardness, abrasion resistance, and chemicals resistance.

In view of the above, the diversified and customized color pattern film for metal shell prepared from the transparent polymer substrate, the ink layer, and the adhesive layer according to the present invention, can be directly pressed and attached onto a metal sheet material or coil material to form a color grain metal plate material or coil material, which can be subsequent punched and subjected to other processing, so the problems of the conventional art that the yield of adhesive wet film coating process is not easily controlled and complex post-processes are still required after molding are addressed, and the present invention has advantages of quick and successive production of the metal shell. Further, the appearance of the color pattern film for metal shell of the present invention is diversified, and the appearance patterns and words can be positioned.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A color pattern film for metal shell, comprising:
a transparent polymer substrate;
a releasing coating layer, located on the transparent polymer substrate;
a protective layer, located on the releasing coating layer;
an ink layer, located on the protective layer; and
an adhesive layer, located on the ink layer, wherein the adhesive layer at least comprises a base resin which is one of resin systems selected from ethylene-vinyl acetate (EVA), polyester (PET) resin, and polyolefin resin.

2. The color pattern film for metal shell according to claim 1, wherein the adhesive layer further comprises a tackifier, a plasticizer, an antioxidant, and a wax.

3. The color pattern film for metal shell according to claim 1, wherein a solid content of the adhesive layer is between 90 and 100 wt %.

4. The color pattern film for metal shell according to claim 1, wherein the adhesive layer further comprises a thermosetting resin.

5. The color pattern film for metal shell according to claim 4, wherein the thermosetting resin is one selected from a resin system consisting of acrylic resin and urethane resin or composites thereof.

6. The color pattern film for metal shell according to claim 1, wherein a melting temperature of the adhesive layer is lower than 200° C.

7. The color pattern film for metal shell according to claim 1, wherein a glass transition temperature of the adhesive layer is higher than 60° C.

8. The color pattern film for metal shell according to claim 1, wherein a content of the base resin in the adhesive layer is between 20 and 80%.

9. The color pattern film for metal shell according to claim 1, wherein the adhesive layer is free of solvents.

10. The color pattern film for metal shell according to claim 1, wherein a thickness of the adhesive layer is 10-100 μm.

11. The color pattern film for metal shell according to claim 1, wherein the transparent polymer substrate is made of a material without polyvinyl chloride resin.

12. The color pattern film for metal shell according to claim 1, wherein a thickness of the transparent polymer substrate is 20-200 μm.

13. The color pattern film for metal shell according to claim 1, wherein a material of the transparent polymer substrate comprises acrylic resin, PET resin, polystyrene (PS) resin, polypropylene (PP) resin, polyethylene (PE) resin, polycarbonate (PC) resin, or polyurethane (PU) resin.

14. The color pattern film for metal shell according to claim 1, wherein a material of the protective layer is one resin selected from a resin system consisting of acrylic resin, PU resin, epoxy resin, and PET resin.

15. The color pattern film for metal shell according to claim 1, wherein the protective layer is composed of a thermosetting resin and a UV curing resin.

16. The color pattern film for metal shell according to claim 15, wherein the protective layer further comprises a curing agent for the thermosetting resin and a photoinitiator for the UV curing system.
